(19) United States
(12) Patent Application Publication
(10) Pub. No.: US 2005/0278751 A1
(43) Pub. Date: Dec. 15, 2005

(54) Portable terminal

(75) Inventors: Isao Wada, Hitachinaka (JP); Junichi Sakamura, Musashimurayama (JP); Yutaka Matsunobu, Hitachiota (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/893,726

(22) Filed: Jul. 15, 2004

(30) Foreign Application Priority Data
May 13, 2004 (JP) 2004-143830

(51) Int. Cl. H04N 7/173; H04N 7/20; H04N 7/16

(52) U.S. Cl. 725/62; 725/63; 725/100

(57) ABSTRACT

A portable terminal providing TV broadcast reception functionality, that achieves reduced power consumption. A CPU controls lighting of a back light via a back light control part. The CPU controls a CM identifier detection part to detect a commercial identifier from the demodulated signal of the TS of a broadcast wave received in real time by a portable terminal or from the demodulated signal of the TS from a replay data holding part. The result of this detection operation is stored in a memory part. A decision is made as to whether the start time of commercials has arrived from the detected result as read compared to the current time. If the time to start commercials has arrived a back light stops lighting and this discontinuance of lighting continues until the end time of the commercials. When the end time of the commercials is reached the back light lights again.

### INCORPORATION BY REFERENCE

The present application claims priority from Japanese application JP2004-143830 filed on May 13, 2004, the content of which is hereby incorporated by reference into this application.

### BACKGROUND OF THE INVENTION

The present invention relates to a portable terminal that receives a TV broadcast radio wave.

Portable type television (hereinafter “TV”) telephone systems aiming to provide improved visual recognition on a display screen during conversation have been proposed. Such conventional portable TV type systems (e.g. JP-A-2003-174503) have back light control means that control back light lighting irradiating the screen of a display means in response to whether there is control input from an operation means, whether incoming audio input from a calling party is detected by an incoming voice input detection means and whether voice input of a user is detected by a voice input detection means.

Further, signal processing methods and systems therefor have been proposed the object of which is to reproduce the recorded TV program or the like except the parts of commercials. Such methods and systems (e.g. JP-A-9-284706) operate by detecting repetition of silent parts of audio signals of a broadcast TV program, deciding whether such a silent part is a commercial and if so, ascertaining the starting position of the commercial and the length thereof or the position of the commencement of the commercial and the position of the completion of the commercial and recording that information together with the program itself to a recording medium or a separately installed recording device. When the program is reproduced the commercial parts are shipped during the reproduction.

An issue affecting the above described portable TV telephone system is that in order to control power consumption of the internally housed TV broadcast reception circuit, control of back light lighting is only performed when the operation means is not operated, when the incoming voice input detection means does not detect an incoming call and when the voice input detection means does not detect voice input. This creates the problem that when the incoming voice input detection means is constantly detecting incoming voice input and a user does not operate the operation means as when that portable type TV telephone system is receiving TV broadcast, back light lighting control can not be performed by back light control means.

On the other hand, the above described signal processing methods and systems are not related to TV broadcast reception systems that are portable (moveable) like the portable TV type telephone systems but are instead fixed type (non portable) TV broadcast reception systems. These signal processing systems (TV broadcast reception equipment) operate by playing out only those parts of the total content of TV broadcast recorded to a storage medium or storage device (e.g. an electromagnetic recording/reply device) provided separately from that TV broadcast reception system itself, that are not commercials, and do not provide a user with broadcast content minus the commercials during reception of the TV broadcast in real time, not leading to a suppression of power consumption.

As is clear from the description of the above two types of conventional technology, in the case of either the portable type TV telephone system or the signal processing method and system it is difficult to achieve a reduction in power consumption of a portable terminal providing TV broadcast reception functionality.

Accordingly, it is an object of the present invention to provide a portable terminal having TV broadcast reception functionality for which reduction of power consumption can be achieved.

### SUMMARY OF THE INVENTION

The portable terminal according to the present invention is a portable terminal comprising
a notification part for notifying a user of the contents of a broadcast program transmitted by a TV broadcast wave received,
an identifying part for identifying a type of program broadcast from TV broadcast waves either received or being received,
a determining part for determining whether or not the type of program identified by the identifying part indicates that the program is a program desired by the user, and
a power control part, that reduces or cuts off power supply to the notification part when the determining part determines that a program is not desired by a user at least during the interval until the broadcast of that program is completed.

According to a preferred embodiment of the present invention a program not desired by a user includes at least a commercial.

According to a further embodiment of the present invention the notification part includes an image display part for displaying image information constituting a broadcast program as a visible image and an audio output part for outputting audio information constituting the broadcast program as audible sound.

According to another embodiment of the present invention the TV broadcast wave is a digital TV broadcast wave and the identifying part identifies whether a program broadcast is a commercial by detecting the existence or otherwise of a predetermined commercial identifier included in the digital TV broadcast wave.

According to yet another embodiment of the present invention, the identifier includes at least information on the start time of a commercial and information on the duration of the broadcast of the commercial.

According to yet another embodiment of the present invention, the image display part comprises a liquid crystal display screen and a back light for irradiating the liquid crystal display screen and the power control part performs control to switch on/off the lighting of the back light and/or control of the audio output part, in response to results of identification performed by the identification part.

According to yet another embodiment of the present invention control mode for reducing or cutting power supply to the notification part by the power control part can be set by a user.

According to yet another embodiment of the present invention the TV broadcast wave is an analog TV broadcast wave and the identification part is formed so as to identify whether or not a broadcast program is a commercial by identifying whether or not an audio signal included in the analog TV broadcast wave either broadcast or being broadcast is in stereo broadcast mode.

The present invention enables a reduction to be achieved in power consumption for a portable terminal providing TV broadcast reception functionality.

Other objects, features and advantages of the invention will become apparent from the following description of the embodiments of the invention taken in conjunction with the accompanying drawings.

### BRIEF DESCRIPTION OF THE DRAWINGS

FIG. 1 is a block drawing showing the entire structure of a portable terminal related to a first embodiment of the present invention.

FIG. 2 is an explanatory drawing showing the structure of a TV signal related to the first embodiment of the present invention.

FIG. 3 is a flow chart showing the processes operated by each part of the portable terminal shown in FIG. 1.

FIG. 4 is a block diagram of the overall structure of a portable terminal according to another embodiment of the present invention.

FIG. 5 is a flow chart showing the processes operated by each part of the portable terminal shown in FIG. 4.

### DESCRIPTION OF THE EMBODIMENTS

Some embodiments of the present invention will now be described with reference to the drawings.

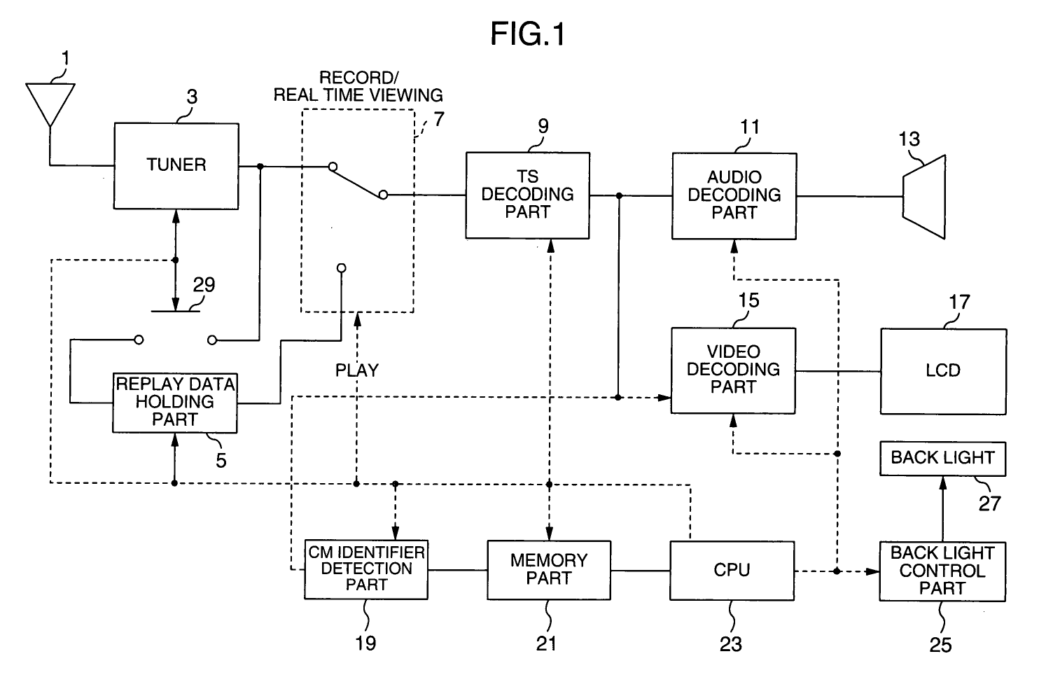

FIG. 1 is a block drawing showing the entire structure of a portable terminal related to a first embodiment of the present invention. The terminal shown in FIG. 1 provides functionality for receiving radio waves of a digital TV broadcast in addition to the call functionality of a portable telephone device (between itself and the terminal of another party) that provides the main functionality of the portable telephone. As shown in FIG. 1, that portable terminal consists of an antenna 1, a tuner 3, a replay data holding part 5, a data switch over part 7, a transport stream (hereinafter “TS”) decoding part 9, an audio decoding part 11 and a speaker 13. Further, in addition to those parts, that portable terminal has a video decoding part 15, a liquid crystal display part (hereinafter “LCD”) 17, a commercial (hereinafter “CM”) identifier detection part 19, a memory part 21, a CPU 23, a back light control part 25, a back light 27 and a record switch 29.

The antenna 1 receives broadcast of radio waves from a plurality of digital TV broadcast stations (not shown in the drawing) through a plurality of digital TV broadcast base stations (relay stations, not shown in the drawing), and outputs the digital TV broadcast radio waves thus received to the tuner 3. Operating under control from the CPU 23, the tuner 3 selects a broadcast radio wave from a specific broadcast station (digital TV station, not shown in the drawing) from among the plurality of broadcast radio waves received by the antenna 1 and outputs the selected broadcast radio wave to the data switch over part 7 and the record switch 29 as a TS.

The record switch 29 switches between ON and OFF under control from the CPU 23. That is to say, when the portable terminal is set by the CPU 23 to record mode, the record switch 29 operates such that the TS output from the tuner 23 is input to the replay data holding part 5. When the portable terminal is set by the CPU 23 to record/real time view mode, the record switch 29 switches to ON simultaneous with the closing of the contact at the tuner 3 side by the data switch over part 7.

The replay data holding part 5 transitions to an operative drive state as the portable terminal is set to record mode by the CPU 23, such that the replay data holding part 5 records the TS from the tuner 3 output through the record switch 29 and transitions to a drive state as the portable telephone is set to the replay mode by the CPU 23, and outputting the TS data held to the switch over part 7.

Operating under control from the CPU 23, the data switch over part 7 operates a switch over function closing alternatively the contact at the tuner 3 side or the contact of the replay data holding part 5 side, thereby alternatively outputting to the TS decoding part 9 either the TS output from the tuner 3 or the TS replay data held in the replay data holding part 5. That is to say, the data switch over part 7, operating under control from the CPU 23, inputs the TS output from the tuner 3 side to the TS decoding part 9, by closing the contact at the tuner 3 side when the portable terminal is set to real time view mode or when the portable terminal is set to record/real time view mode. Again, operating under control from the CPU 23, the data switch over part 7 inputs the TS output and recorded from the replay data holding part 5 side to the TS decoding part 9 by closing the contact at the replay data holding part 5 side when the portable terminal is set to record mode or when the portable terminal is set to replay mode.

Operating under control from the CPU 23 the TS decoding part 9 inputs the TS of replay data output from the replay data holding part 5 via the data switch over part 7 or the TS of broadcast radio waves output from the tuner 3 via the data switch over part 7. After demodulating the TS of those broadcast radio waves or the TS of the replay data, the TS decoding part 9 outputs those demodulated signals alternatively to the audio decoding part 11, the video decoding part 15 and the CM identifier detection part 19 respectively. The audio decoding part 11, operating under control from the CPU 23, extracts audio data included in that digital data from the digital data output from the TS decoding part 9, converts that audio data into an analog audio signal and outputs that analog audio signal via the speakers 13 as audio.

Video decoding part 15, operating under control from the CPU 23, extracts image data (including static and moving images) included in digital data from the digital data output from the TS decoding part 9, converts that image data into an analog image (video) signal which is displayed as a visible image on the LCD 17. Operating under control from the CPU 23, the CM identifier detection part 19 detects information related to the position and time base of a commercial from among program arrangement information transmitted in advance from a broadcast station for example (not shown in the drawing), and outputs that information as the result of that detection operation to the memory part 21. Alternatively, the CM identifier detection part 19 checks for the existence of determined identifier information (a special identifier code set in advance for example) included in the broadcast radio wave received, showing that a program is a commercial and when such identifier information is detected, the CM identifier detection part 19 outputs information including the position on the time base for the commercial as well as the length on the time base for the interval up until the next identifier information is detected, to the memory part 21.

Operating under control from the CPU 23, the back light control part 25 performs control of the lighting of the back light 27 that irradiates the screen (display) of the LCD 17. Here, a transmissive type LCD is employed for the LCD 17 and the back light 27 is [attached to/equipped on] the LCD 17.

The CPU 23, controlling the tuner 3 based on channel selection instructions from a user input via a control part (not shown in the drawing) of the portable terminal, selects a broadcast radio wave from the broadcast channel (not shown in the drawing) corresponding to those channel selection instructions from the broadcast radio waves (arising from the actions of the user) received by the antenna 1 in response to the tuner 3. Further, when the mode selected by the user via the operating part (not shown in the drawing) is for example the real time view mode, the CPU 23 controls the data switch over part 7 so that the contact of the data switch over part 7 closes the output side of the tuner 3, makes the record switch 29 go to OFF and puts the replay data holding part 5 into an operation stopped condition. Then, the CPU 23 puts the TS decoding part 9, audio decoding part 11, video decoding part 15, CM identifier detection part 19, memory part 21 and back light control part 25 in an operating condition.

In this way, as radio waves of digital TV broadcast received by the antenna 1 are input to the tuner 3, the broadcast radio wave of a specific broadcast channel (not shown in the drawing) from among the broadcast channels are selected at the tuner 3, and the broadcast radio wave thus selected is output as a TS to the TS decoding part 9 via the data switch over part 7. This TS, after being demodulated at the TS decoding part 9, is delivered respectively to the audio decoding part 11, the video decoding part 15 as well as the CM identifier detection part 19. Thereafter, at the audio decoding part 11, audio data included in the demodulated signal from the demodulated signal of that TS is extracted and converted to an analog audio signal which is output externally via the speakers 13 as audio. Moreover, at the video decoding part 15 image data (including both static and moving images) included in the demodulated signal from the demodulated signal of that TS, is extracted and converted to an analog image (video) signal then displayed as a visible image on the LCD 17.

Further, at the CM identifier detection part 19 information related to the length and position on the time base of a commercial from the demodulated signal of the TS is detected and that information is then stored in the memory part 21. The CPU 23 then reads that information from the memory part 21 at appropriate time intervals, performing control via the back light control part 25 to stop lighting of the back light 27 or to decrease the illumination of light irradiated from the back light 27 when the CPU 23 decides that a time frame in which a commercial is to be received has arrived. In this way, it is possible to economize on the consumption of electric power stored in a battery (not shown in the drawing) that provides the driving power for the portable terminal.

Further, when the mode selected by a user via the control part (not shown in the drawing) is for example the record/real time viewing mode, the CPU 23 controls the data switch over part 7 such that the contact of the data switch over part 7 closes the output side of the tuner 3, switches the record switch 29 to ON and puts the replay data holding part 5 into an operating condition. Then, the CPU 23 puts the TS decoding part 9, audio decoding part 11, video decoding part 15, CM identifier detection part 19, memory part 21 and back light control part 25 in an operating condition. In this way, as radio waves of digital TV broadcast received by the antenna 1 are input to the tuner 3, the broadcast radio wave of a specific broadcast channel (not shown in the drawing) from among the broadcast channels are selected at the tuner 3, and the broadcast radio wave thus selected is output as a TS to the TS decoding part 9 via the data switch over part 7, and output to the replay data holding part 5 also, via the record switch 29. Then, that TS is recorded in the replay data holding part 5. The operations of each part of the portable terminal for real time viewing are the same as those described above.

When the mode selected by the user via the operating part (not shown in the drawing) is for example the record mode, the CPU 23 moves the contact of the data switch over part 7 to a neutral position that is neither to the output side of the tuner 3 nor the output side of the replay data holding part 5 and holds that position, turns the record switch 29 to ON and facilitates storage of the TS output from the tuner 3 in the replay data holding part 5.

Further, when the mode selected by the user via the operating part (not shown in the drawing) is for example the replay mode, the CPU 23 turns the record switch 29 to OFF and operates the data switch over part 7 such that the contact of the data switch over part 7 closes the output side of the replay data holding part 5. In this way, the TS recorded in the replay data holding part 5 is replayed in the way described above.

In the same manner as applies with respect to demodulated signals of TS for real time viewing, in the case of demodulated signals of TS recorded in the replay data holding part 5 also, information concerning the length and position on the time base of commercials is detected at the CM identifier detection part 19 and that information is stored in the memory part 21. The CPU 23 then reads that information from the memory part 21 at appropriate time intervals performing control to stop lighting of the back light 27 via the back light control part 25 or to decrease the illumination of light irradiated from the back light 27 when the CPU 23 decides that a time frame in which a commercial is to be played has arrived.

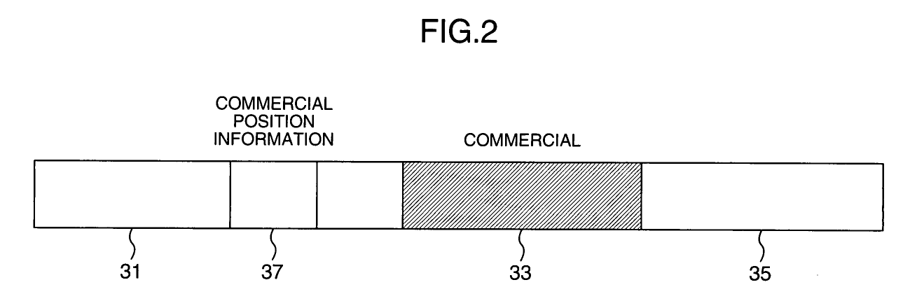

FIG. 2 is an explanatory drawing showing the structure of a TV signal related to the first embodiment of the present invention.

As shown in FIG. 2, the above described TV signal is constituted of a main broadcast signal 31 containing the contents of the broadcast program, a commercial broadcast signal 33 and a main broadcast signal 35 broadcast after the commercial broadcast signal 33. A TV broadcast involves transmission of broadcast content from a main station that provides the key station, to other broadcast stations in different regions. At each broadcast station of those different regions processes are performed to replace the commercial parts of that transmitted content with commercials appropriate for each of those different regions in order to provide an appropriate regional flavor to the broadcast content. Commercial position information 37 providing information that shows the starting position and the ending position of a commercial broadcast signal 33 is inserted in the main broadcast signal 31 in order to facilitate easy performance of this replacement process.

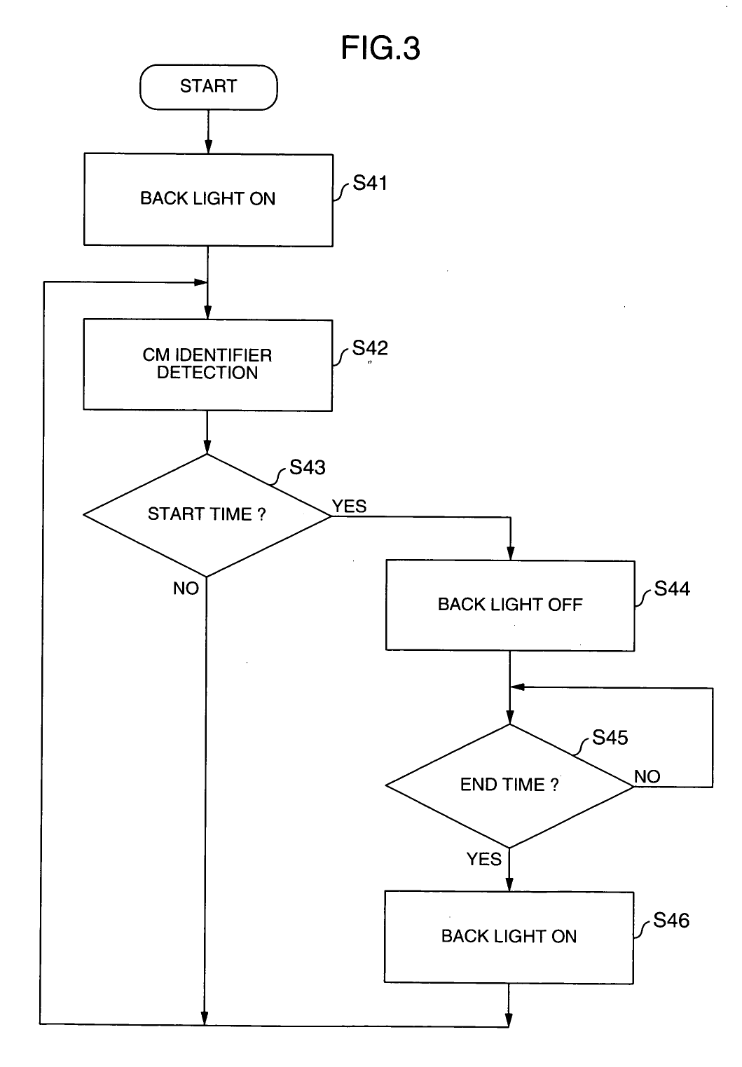

FIG. 3 is a flow chart showing the processes operated by each part of the portable terminal shown in FIG. 1.

Referring to FIG. 3, firstly the CPU 23 lights the back light 27 via the back light control part 25 (step S41). Next, the CPU 23 controls the CM identifier detection part 19 initiating detection by part 19 of a commercial identifier (e.g. a specific identifier code as described above or the like) from among the demodulated signal of the TS output from the replay data holding part 5 or the demodulated signal of the TS of the broadcast radio wave received in real time via the portable terminal, and records the result of that detection operation by the commercial identifier detection part 19 in the memory part 21 (step S42).

Next, the CPU 23 reads the result of that detection from the memory part 21 and makes a determination from that detected result and the existing time as to whether or not the time for commencement of a commercial has arrived (step S43). Here, a method whereby the CPU 23 utilizes time information wirelessly transmitted from a base station (not shown in the drawing) forming part of a service network for portable telephones for example or a method utilizing time information supplied from an internal master (not shown in the drawing) in the portable terminal, can be envisaged as methods by which the CPU 23 recognizes the current time.

If the result of the above described determination is that the start time for commercials has not arrived (No at step S43), the CPU 23 returns to operate the processes shown at step S42. On the other hand, if the result of that determination is that the start time for commercials has arrived (Yes at step S43), via the back light control part 25, the CPU 23 stops lighting of the back light 27 (step S44). This stoppage of lighting of the back light 27 continues during the period until the CPU 23 recognizes that the start time of those commercials has arrived (No at step S45). When the CPU 23 recognizes that the start time for the commercials has arrived (Yes at step S45), via the back light control part 25, the CPU 23 again lights the back light 27 (step S46) and returns to operate the processes shown at step S42.

As described, according to the first embodiment of the present invention, during the time interval from the start time of commercials until the end time of the commercials it is possible to economize on the consumption of electric power stored in a battery (not shown in the drawing) that provides the driving power for the portable terminal by stopping lighting of the back light 27, thereby enabling a reduction in power consumption in a portable terminal equipped with functionality for reception of TV broadcast.

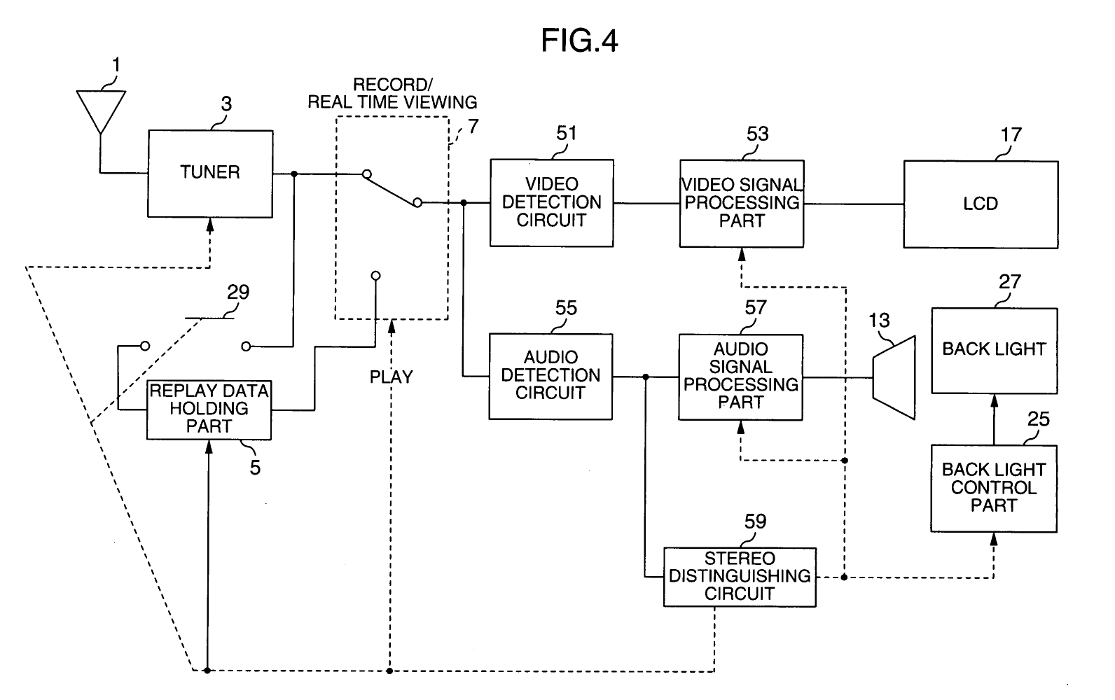

FIG. 4 is a flow chart showing the overall structure of a portable terminal according to another embodiment of the present invention.

The above described embodiment of this invention was described with respect to a portable terminal having functionality for reception of digital TV broadcast waves, however the embodiment of the present invention illustrated in FIG. 4 concerns a portable terminal having functionality for reception of analog TV broadcast waves.

The portable terminal of this embodiment differs to that of the portable terminal shown in FIG. 1 in that instead of having the TS decoding part 9, audio decoding part 11, video decoding part 15, CM identifier detection part 19, memory part 21 and CPU 23 shown in FIG. 1 this embodiment provides instead, a video detection circuit 51, a video signal processing part 53, an audio detection circuit 55, an audio signal processing part 57 and a stereo distinguishing circuit 59. In all other respects, the structure of the portable terminal according to this embodiment is the same as that of the portable terminal shown in FIG. 1 and the same symbols are applied to those parts of the portable terminal shown in FIG. 4 that are the same as those shown in FIG. 1 as are applied to those parts in FIG. 1, while the description of those parts is omitted here.

The video detection circuit 51 of FIG. 4 detects (demodulates) a TV broadcast wave output from the tuner 3 via the data switch over part 7 or a TV broadcast wave replayed from the replay data holding part 5 via the data switch over part 7, extracting the audio signals therefrom before outputting the audio signals extracted to the audio signal processing part 57 and the stereo distinguishing circuit 59. The audio signal processing part 57, under control of the stereo distinguishing circuit 59, performs prescribed signal processing operations on audio signals from the audio detection circuit 55 and outputs audio externally via the speakers 13.

In the same manner as the CPU 23 shown in FIG. 1, this stereo distinguishing circuit 59 controls the tuner 3, replay data holding part 5, data switch over part 7, video signal processing part 53, audio signal processing part 57 and back light control part 25. Based on audio signals in a TV broadcast signal, the stereo distinguishing circuit 59 detects commercial parts included in that signal. This stereo distinguishing circuit 59 detects whether audio signals in a TV broadcast signal are for example stereo broadcast mode, mono broadcast mode or bilingual broadcast mode based on an audio signal from the audio detection circuit 55. If, as a result of this detection operation that audio signal is recognized as being stereo broadcast mode, the stereo distinguishing circuit 59 decides that audio signal is a commercial part and, via the back light control part 25, stops lighting of the back light 27. On the other hand, if the stereo distinguishing circuit 59 as a result of the detection operation recognizes the audio signal as mono broadcast mode or bilingual broadcast mode, the stereo distinguishing circuit 59 determines that audio signal is not a commercial part (in other words is part of a normal broadcast program) and no control to stop lighting of the back light 27 is performed.

Generally, commercial parts of a TV broadcast are broadcast in stereo and the majority of ordinary program broadcasts are broadcast in mono or are a bilingual broadcast. According to this embodiment of the present invention, the start point and end point on the time base of commercial parts are recognized by monitoring of the audio multiplexing mode of a TV broadcast from the stereo distinguishing circuit 59, and via the back light control part 25, the lighting of the back light 27 is stopped where a commercial part exists.

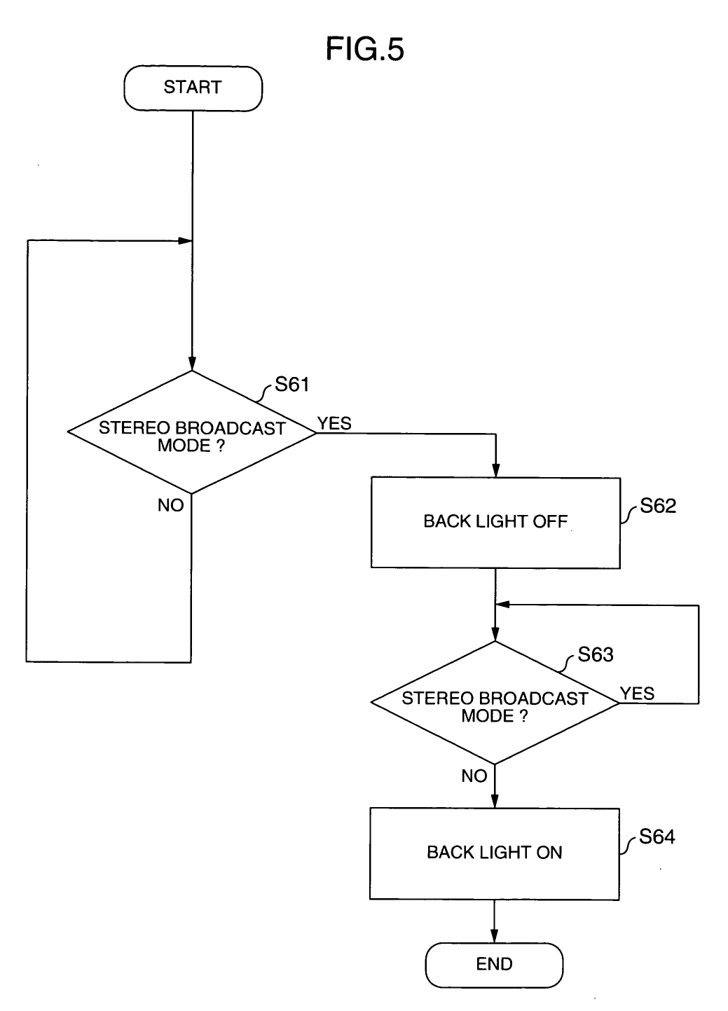

FIG. 5 is a flow chart showing the processes operated by each part of the portable terminal shown in FIG. 4.

Referring to FIG. 5, based on an audio signal from the audio detection circuit 55, the stereo distinguishing circuit 59 first checks to ascertain whether that audio signal is in stereo broadcast mode (step S61). If the result of this check is a determination that the audio signal is not in stereo broadcast mode (No at step S61) no control is executed via the back light control part 25 to stop lighting of the back light 27. On the other hand, if the result of the checking operation by the stereo distinguishing circuit 59 is a determination that the audio signal is in stereo broadcast mode (Yes at step S61), the stereo distinguishing circuit 59 performs control via the back light control part 25 to stop lighting of the back light 27 (step S62). Next, while control to stop lighting of the back light 27 is being performed, the stereo distinguishing circuit 59 rechecks at appropriate time intervals, to ascertain, based on the audio signal from the audio detection circuit 55, whether the audio signal is in stereo broadcast mode (step S63). If as a result of this check the stereo distinguishing circuit 59 determines that the audio signal is in stereo broadcast mode (Yes at step S63), the stereo distinguishing circuit 59 continues to perform control via the back light control part 25 to stop lighting of the back light 27. On the other hand, if as a result of the checking the stereo distinguishing circuit 59 determines that the audio signal is not in stereo broadcast mode (No at step S63), the stereo distinguishing circuit 59 performing control via the back light control part 25, lights the back light 27 again (step S64) thereby completing the series of processing operations by the stereo distinguishing circuit 59.

As described this other embodiment according to the present invention furnishes the same effects as those of the first embodiment according to the present invention.

Although the invention has been described above by reference to certain exemplary embodiments of the invention, the invention is not limited to the embodiments described above. Modifications and variations of the embodiments described above will occur to those skilled in the art, in light of the above teachings. For example, in respect of each of the above described embodiments an explanation was provided concerning reducing consumption of power stored in a battery (not shown in the drawing) that provides the driving power of the portable terminal during time periods in which commercial parts are broadcast, by stopping lighting of the back light 27, however simultaneous with performance of such control to stop lighting of the back light 27 consumption of power stored in that battery can also be reduced by performing control to turn off audio output via the speakers 13 together with the images (video) output via the LCD 17.

Again, it is also suitable to provide user selectable settings, for example a menu screen providing the settings (1) audio on/back light lighting, (2) audio on/back light off, (3) audio off/back light lighting and (4) audio off/back light off, stored in advance in the memory part 21 or in a storage region of the stereo distinguishing circuit 59, such that when the content of a TV broadcast switches from a normal program broadcast to commercials the menu screen is displayed on the LCD 17 allowing the user to select which setting they prefer. In other words, if the user presses one of the displayed menu settings consumption of power from the battery can be reduced in accordance with the indicated selection.

1. A portable terminal comprising:
a notification part for notifying a user of the contents of a broadcast program transmitted by TV broadcast wave received;
an identifying part for identifying a type of program broadcast from TV broadcast wave either received or being received;
a determining part for determining whether or not the type of program identified by said identifying part indicates that the program is a program desired by the user; and
a power control part, that reduces or cuts off power supply to said notification part when said determining part determines that a program is not desired by the user at least during the interval until the broadcast of said program is completed.

2. A portable terminal according to claim 1 wherein said program not desired by a user includes at least a commercial.

3. A portable terminal according to claim 1 wherein said notification part includes an image display part for displaying image information comprising a broadcast program as an image and an audio output part for outputting audio information comprising the broadcast program as audio.

4. A portable terminal according to claim 1 wherein said TV broadcast wave is a digital TV broadcast wave and said identifying part identifies whether a program broadcast is a commercial by detecting the existence or otherwise of a predetermined commercial identifier included in said digital TV broadcast wave.

5. A portable terminal according to claim 4 wherein said identifier includes at least information on the start time of a commercial and information on the duration of the broadcast of the commercial.

6. A portable terminal according to claim 1 wherein said image display part comprises a liquid crystal display screen and a back light for irradiating said liquid crystal display screen and said power control part performs control to switch on/off the lighting of said back light and/or control of said audio output part, in response to results of identification performed by said identification part.

7. A portable terminal according to claim 1 wherein control mode for reducing or cutting power supply to said notification part by said power control part can be set by a user.

8. A portable terminal according to claim 1 wherein said TV broadcast wave is an analog TV broadcast wave and said identification part identifies whether or not a broadcast program is a commercial by identifying whether or not the audio signal included in said analog TV broadcast wave either received or being received is in stereo broadcast mode.
